(19) United States
(12) Patent Application Publication
(10) Pub. No.: US 2019/0073913 A1
(43) Pub. Date: Mar. 7, 2019

(54) SYSTEM AND METHOD FOR INTELLIGENTLY GENERATING DATA FOR LEARNING INTERACTIONS FROM TEXTUAL CONTENT BASED ON LEARNING GOALS

(71) Applicant: Harbinger Knowledge Products Private Limited, Pune (IN)

(72) Inventors: Vikas Vasudeo JOSHI, Pune (IN); Poonam Ashish JAYPURIYA, Pune (IN); Shweta Mandar KULKARNI, Pune (IN)

(21) Appl. No.: 16/123,920

(22) Filed: Sep. 6, 2018

(30) Foreign Application Priority Data
Sep. 7, 2017 (IN) 201721031667

(51) Int. Cl. G09B 5/00; G06F 17/22

(52) U.S. Cl. CPC G09B 5/00; G06F 17/2765; G06F 17/2247

(57) ABSTRACT

A system and method for generating learning interactions data mapping to learning goals are described. This invention comprising an Intelligent Learning Interaction Data Generator that processes textual content to generate learning interactions data meeting learning goals specified by external eLearning Application, consists of Content Input Handler, Theme Selector, Learning Element Generator and Learning Interaction Selector. The Textual Content is processed by external Natural Language Processing and machine learning libraries for generating Relationship Data, that is further used to identify Themes and generate learning elements. Learning interactions are created using these learning elements for various themes. Learning interactions are then shortlisted as per the learning goals shared by the external application. Learning interactions and learning elements is then shared using XML with the external eLearning Application for presentation thereof. The invention finds application in websites, presentations, online advertising, and e-commerce.

### RELATED APPLICATION

This application claims the benefit of priority under 35 U.S.C§ 119 of Indian Patent Application No. 201721031667, filed on Sep. 7, 2017, the contents of which is hereby incorporated by reference in its entirety.

### FIELD

The present invention relates to a system and method for intelligently generating learning interactions data from textual content using previously developed and available natural language processing and machine learning technology; and more particularly to a system and method that works according to the learning goals specified by an external eLearning application.

### BACKGROUND

A system and method for intelligently generating learning interactions data from textual content using available natural language processing and machine learning technology are described. This invention comprises an Intelligent Learning Interaction Data Generator that processes textual content to generate data for learning interactions that meet the learning goals specified by an external eLearning Application. The Intelligent Learning Interaction Data Generator includes a Content Input Handler, a Theme Selector, a Learning Element Generator and a Learning Interaction Selector. The external eLearning Application provides the learning goals and the corresponding textual content to the system described in this invention. The Textual Content is formatted by eLearning Application User as per the Content Format Guide defined in this invention. The Formatted Textual Content is then processed by external Natural Language Processing and machine learning libraries for generating Relationship Data. This invention uses the Relationship Data to identify Themes and to generate learning elements around the Themes. It then shortlists the learning interactions that could help achieve the learning goals using the available themes and learning elements. A Learning Interaction XML comprising learning interactions along with the learning elements is produced and sent to the external eLearning Application. The eLearning Application can use the Learning Interaction XML for presenting learning interactions. The invention could also be used in websites, presentations, electronic documents, online advertising, e-commerce and other applications in which interactivity adds value.

### OBJECTS

An object of this invention is to provide a system and a method for intelligently generating learning interactions data from textual content in accordance with the learning goals specified by an external eLearning application.

### SUMMARY OF THE INVENTION

An object of this invention is to provide a system and a method for intelligently generating learning interactions data from textual content in accordance with the learning goals specified by an external eLearning application.

In accordance with this invention, an external eLearning Application sends textual content to a Content Input Handler. The Content Input Handler provides a Content Format Editor for eLearning Application User to format the content as per a Content Format Guide included in this invention. Once the eLearning Application User edits content as required and confirms the format, the Content Input Handler sends the Formatted Textual Content for further action by various available Natural Language Processing and machine learning libraries which are not part of the invention. These libraries together generate Relationship Data that include key words appearing in the Formatted Textual Content, their weightages, the relationships between such words, the type of each relationship, and a summary of content related to each key word.

The Relationship Data are then provided as input to the Theme Selector and the Learning Element Generator.

Textual Content input to the system could include multiple Themes, each of which may represent a key point being described in the content. For example, a textual content input that describes theories of human learning might include three themes such as behavioral, cognitive, and sociocultural approaches to learning. Theme Selector identifies such Themes based on content relationships included in the Relationship Data. For example, the relationship data might show several words such as reward, punishment, and feedback that occur in connection with the theme of behaviorism. Theme Selector then provides these identified Themes to the Learning Element Generator.

A learning element is a unit of information necessary to produce a Learning Interaction. For example, a learning element can be a question, a response, a brief description, an image, or a relationship between two learning elements. Learning Element Generator aggregates Relationship Data by Themes. It then generates various learning elements as per the format specified by Learning Element Library. The Learning Element Library comprises schema for each learning element supported by this invention. Learning Element Generator then uses the Learning Interaction Library and shortlists all the Learning Interactions that can be built using the generated learning elements. Examples of Learning Interactions could be drag-drop exercise, match-the-pairs exercise, quiz in the form of a game, and an eBook to present content.

Shortlisted Learning Interactions from Learning Element Generator, Themes from Theme Selector and Learning Goal XML from external eLearning Application are then sent to Learning Interaction Selector.

The Learning Interaction Selector first processes the Learning Goal XML received from the external eLearning Application using the Learning Goal Mapper. The Learning Goal XML contains the learning goals specified by the eLearning application as well as the learning interactions supported by the application. Examples of Learning Goals could be knowledge, comprehension, memorization, and evaluation. A Learning Goal Library comprises a mapping of various Learning Interactions with the Learning Goals that could be accomplished using those interactions. Learning Goal Mapper refers the Learning Goal Library to shortlist the Learning Interactions against the Learning Goals specified by the eLearning Application.

The Learning Interaction Selector then processes final list of learning interactions. To process an interaction, the Learning Interaction Selector first looks for Learning Interactions provided by Learning Element Generator. It then determines if this Learning Interaction is useful to achieve the learning goal based on the learning interactions shortlisted by Learning Goal Mapper. If the learning interaction helps achieve a learning goal, it then selects interaction data for each Theme provided by the Theme Selector. It then proceeds with creating Learning Interaction XML, if sufficient learning elements are available for that interaction to occur or rejects the interaction from the shortlist. In this manner, the Learning Interaction Selector creates a final list of possible Learning Interactions together with each interaction's Learning Elements.

The Learning Interaction Selector then passes on the Learning Interaction XML to the external eLearning Application for creating and presenting learning interactions.

### BRIEF DESCRIPTION OF DRAWINGS

Reference will be made to embodiments of the invention, examples of which may be illustrated in the accompanying figures, wherein:

FIG. 1 is a block diagram illustrating a preferred embodiment of the present invention, used in an interactive e-learning content development system;

FIG. 2 is a block diagram that shows the interrelationship of the various components of the preferred embodiment of the Intelligent Learning Interaction Data Generator;

FIG. 3 displays a few sample rules from the Content Format Guide that users of this invention need to follow while preparing input textual content;

FIG. 4 shows a possible format in an XML used by the Learning Element Library for storing the schema for various learning elements;

FIG. 5 shows a possible format in an XML used by the Learning Interaction Library for listing various Learning Elements that are needed to present a learning interaction;

FIG. 6 shows a possible format in an XML used by the Learning Goal Library for mapping each Learning Goal to various Learning Interactions;

FIG. 7 shows the sections of a Learning Goal XML received from the eLearning Application; containing the learning goals specified by the application as well as the learning interactions supported by the application;

FIG. 8 shows the sections of a Learning Interaction XML, comprising interaction data for shortlisted Learning Interactions, for the eLearning Application to process further;

FIG. 9 is a flow chart illustrating the process of intelligently generating learning interaction data from textual content based on the learning goals specified in an e-Learning application; and

FIG. 10 is a flow chart illustrating the process of extending the range of learning goals, learning elements, and learning interactions supported by the Intelligent Learning Interaction Data Generator, and the rules that users need to follow while preparing input textual content.

### DETAILED DESCRIPTION OF THE INVENTION

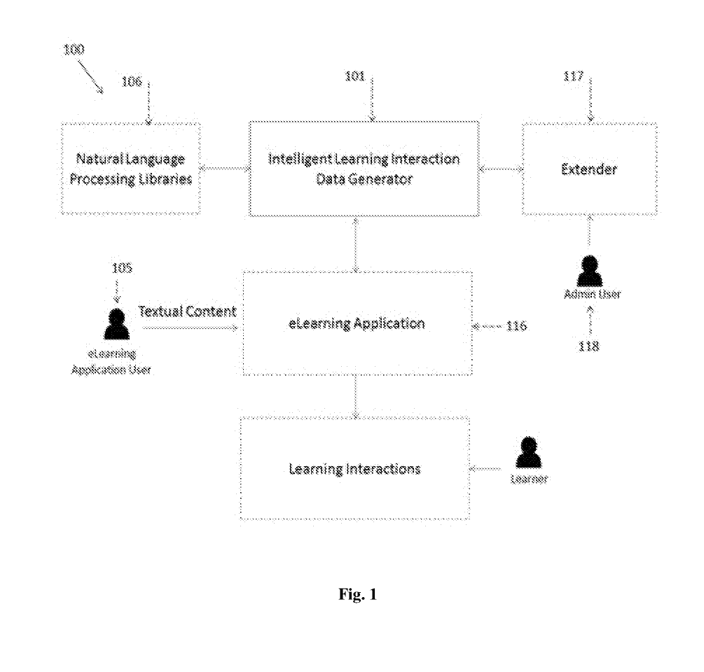

FIG. 1 is a block diagram illustrating a preferred embodiment of the present invention, where there is an eLearning Application 116, not part of this invention, which communicates with Intelligent Learning Interaction Data Generator 101 by sending the Learning Goal XML and Textual Content, and by receiving Learning Interaction XML. Intelligent Learning Interaction Data Generator 101 receives input from the eLearning application, uses available Natural Language Processing Libraries to process the Textual Content. and finally produces Learning Interaction XML for the eLearning Application 116. To extend various libraries which are part of Intelligent Learning Interaction Data Generator 101 there is an Extender 117, which is used by Admin User 118 to add and/or modify various schemas in the libraries.

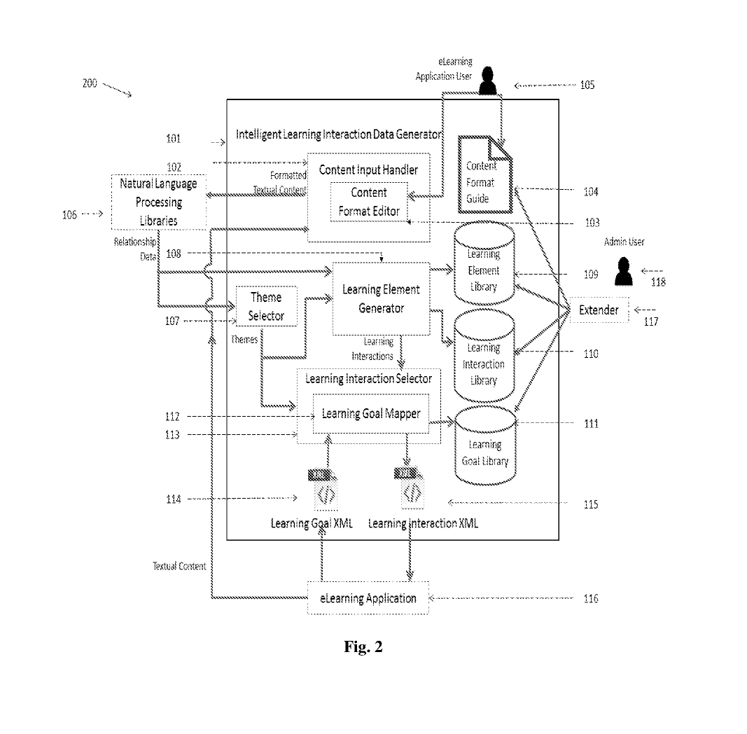

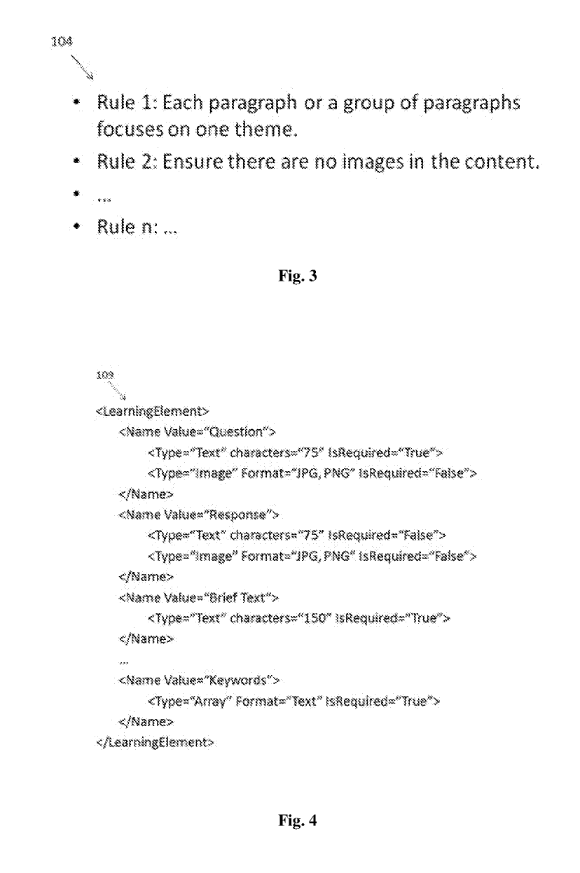

FIG. 2 illustrates the operation of an embodiment of the invention where there is an eLearning Application 116 which sends Learning Goal XML 114 and Textual Content to Intelligent Learning Interaction Data Generator 101. Textual Content is displayed by Content Input Handler 102 in a Content Format Editor 103 so that eLearning Application User 105 can format the content and confirm that the content is as per the rules specified in Content Format Guide 104. The Content Format Guide 104 as part of the embodiment specifies rules for various input formats acceptable for further Natural Language Processing. For example, a rule may specify that content needs to be chunked in paragraphs in such a way that each paragraph or a group of paragraphs focuses on one topic of information. FIG. 3 displays a few sample rules from the Content Format Guide that users of this invention need to follow while preparing input textual content. As will be understood by those who are skilled in the art, the content format could be in various other specific forms without departing from the essential characteristics thereof.

Once the eLearning Application User 105 confirms the content as being in accordance with the Content Format Guide 104, the Formatted Textual Content is then sent for further processing to available Natural Language Processing Libraries 106 which are not part of this invention. Natural Language Processing Libraries analyze the Formatted Textual Content and return Relationship Data to the system. Relationship Data may include the weightages of keywords, the relationships between various words, and the type of each relationship. For example, if the content provided is about the Seven Wonders of the World, then the data returned by the Natural Language Processing Libraries could be the keywords in that content which would be the names of the seven wonders, the relationship between content such as Taj Mahal and Shah Jahan (the creator of Taj Mahal), Taj Mahal and India, and a summary of the Seven Wonders of the World based on the content provided. This Relationship Data is then sent to the Theme Selector 107 for further processing.

Theme Selector 107 as part of the embodiment processes the keywords to determine the Themes from the content. The Themes are the key points being described in the content. For example, in the content referring to the Seven Wonders of the World, each wonder may be construed as a Theme. Once the Themes are selected, the Relationship Data and the Themes from Theme Selector 107 are provided as inputs to the Learning Element Generator 108.

As part of the embodiment, Learning Element Generator 108 first generates various learning elements in the schema specified by Learning Element Library 109. Learning elements can be of various types such as Question, Response, Bullet Point, or Brief Summary. The Learning elements bear a relationship with the Themes from the Theme Selector 107. For example, in the Seven Wonders of the World, each wonder is a Theme. There could be a learning element called ‘brief text’ describing each wonder; a ‘question’ learning element pertaining to the year in which a particular monument was included in seven wonders; a ‘response’ learning element that answers that question; and a ‘location relationship’ learning element between pairs of keywords such as the Taj Mahal and India, or the Statue of Liberty and USA. FIG. 4 demonstrates a possible format in an XML used by the Learning Element Library 109 for storing the schema for various learning elements.

The Learning Element Generator 108 then refers to the Learning Interaction Library 110 for listing all the interactions which could be best created using these learning elements. For example, in continuation of our seven wonders sample, assuming sufficient learning elements such as the names of the attractions, their countries, and a statement highlighting the unique aspect of each attraction were generated; the possible learning interactions could include a flash card showcasing the wonder of the world on the front side of the card and the country on the flip side of the card; a matching exercise between the seven wonders and the countries; or an assessment comprising various questions on the seven wonders.

This shortlisted Learning Interactions from the Learning Element Generator 108 and Themes from Theme Selector 107 are then provided as input to Learning Interaction Selector 113. Learning Interaction Selector 113 as part of the embodiment also accepts the Learning Goal XML 114 as input from eLearning Application 116.

The Learning Goal XML 114 provided by the eLearning Application 116 lists the learning goals it aims to accomplish using the Textual Content. Examples of Learning Goals could be knowledge, comprehension, memorization, and evaluation. The Learning Goal XML 114 also lists the interactions for presenting content as part of the Learning Goal XML 114. This enables Learning Interaction Selector 113 to shortlist only selected Learning Interactions as supported by the eLearning Application 116. FIG. 7 shows the sections of a Learning Goal XML 114 as sent by the eLearning Application 116.

Learning Goal Mapper 112 accepts this Learning Goal XML 114 and maps various learning goals to learning interactions using the Learning Goal Library 111. Learning Goal Mapper 112 refers the Learning Goal Library 111 to shortlist the Learning Interactions which could be used to achieve the learning goals specified by the eLearning Application 116. For example, to achieve the learning goals of memorizing and evaluation, flash card and quiz interactions could be used respectively.

Learning Interaction Selector 113 then processes for final list of learning interactions. To process an interaction, the Learning Interaction Selector 113 first looks for Learning Interactions provided by Learning Element Generator 108. It then determines if this Learning Interaction is useful to achieve the learning goal based on the learning interactions shortlisted by Learning Goal Mapper 112. If the learning interaction helps achieve a learning goal, Learning Interaction Selector 113 then selects interaction data for each Theme provided by the Theme Selector 107. Learning Interaction Selector 113 then proceeds with creating Learning Interaction XML 115, if sufficient learning elements are available for that interaction to occur, or rejects the interaction from the shortlist. In this manner, the Learning Interaction Selector 113 creates a final list of possible learning interactions together with each interaction's learning elements. For example, in the Seven Wonders of the World, if the learning goal was assessment, then the Learning Interaction Selector 113 may select only Quiz interaction for further processing even if it receives Flash cards and Quiz as two possible Learning interactions from the Learning Element Generator 108. This final list of learning interactions is then used to create Learning Interaction XML 115 in the form of a pre-defined schema by Learning Interaction Selector 113.

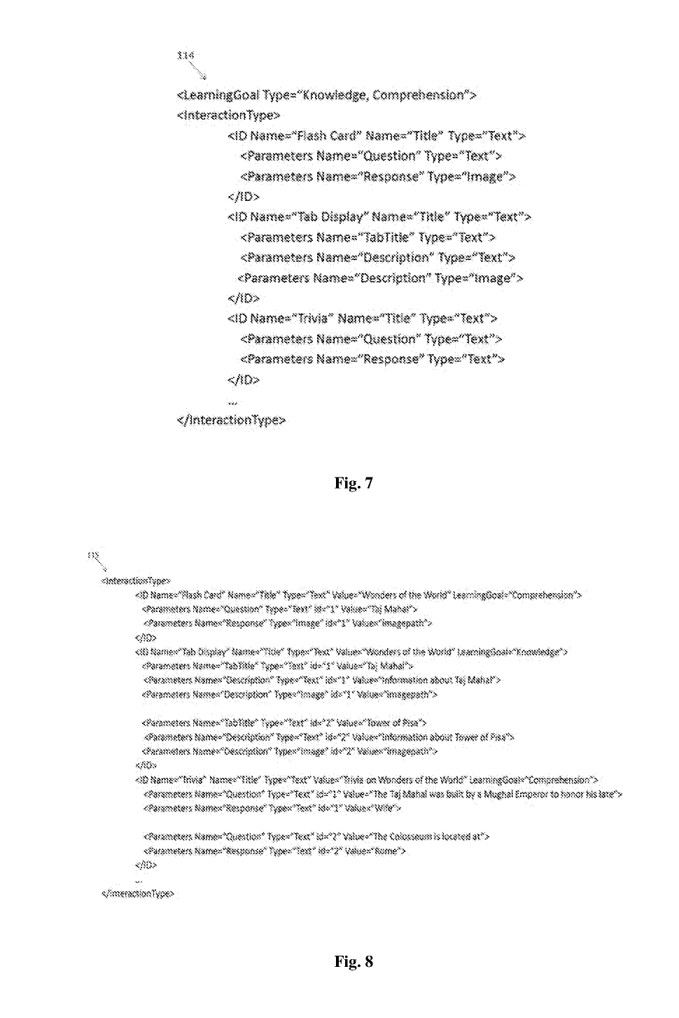

FIG. 8 presents the sections of a Learning Interaction XML 115, comprising interaction data for shortlisted Learning Interactions, for the eLearning Application to process further.

In a preferred embodiment of the invention, the Intelligent Learning Interaction Data Generator 101 includes various libraries and a content format guide, all of which can be extended using an Extender 117. An Admin User 118 uses this Extender 117 to extend various libraries using their respective schema.

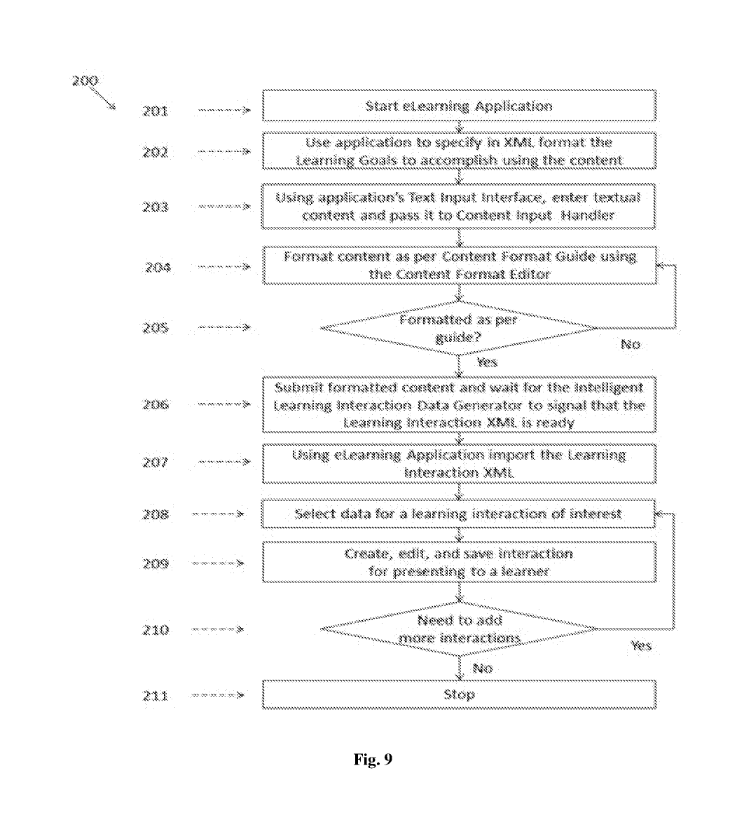

Operation of the preferred embodiment of the invention will now be illustrated with the help of flowchart in FIG. 9. This method is used by the eLearning application user 105, who is the person tasked with creating interactions to achieve certain learning goals from textual content. The method can be initiated by eLearning User 105 by starting the eLearning Application 116 in step 201.

In step 202, the eLearning Application User 105 uses the application to specify the learning goals to be achieved. The eLearning Application stores these learning goals in the pre-defined format of Learning Goal XML 114.

In step 203, eLearning Application User 105 specifies the textual content using the Text Input Interface in the eLearning Application 116. This Textual Content is then passed to Content Input Handler 102 in the Intelligent Learning Interaction Data Generator 101.

In step 204, Content Input Handler 102 presents this textual content along with the Content Format Guide 104 through Content Format Editor 103 to the eLearning User 105.

In step 205, eLearning User is asked to confirm if the if the content is formatted as per the Content Format Guide 104. If yes, the method moves to next step. Else, eLearning User 105 continues to format the content as per the Content Format Guide 104 using the Content Format Editor 103.

In step 206, eLearning User 105 submits Formatted Textual Content and waits for the Intelligent Learning Interaction Data Generator to signal that the Learning Interaction XML 115 is ready for further processing by the eLearning application 116.

Once the Learning Interaction XML 115 is ready, eLearning Application 116 imports it into the application for processing in step 207. Learning Interaction XML 115 includes data only for those Learning Interactions that are supported by the application. So, the application is able to process and present the interactions appropriately.

In step 208, eLearning User 105 selects an interaction of interest from the list of Learning Interactions received as part of Learning Interaction XML 115.

In step 209, eLearning User 105 can process the learning interaction further by creating, editing, and saving it for presenting the interaction to the learner.

Since the Learning Interaction XML 115 can include multiple learning interactions, eLearning User 105 can select to add or customize multiple interactions for the learners. In step 210, eLearning User 105 can decide whether to create additional interactions, and if yes, user is directed to step 209.

In step 211, eLearning User has saved all the interactions of interest from the data. The saved interactions can be delivered to learners.

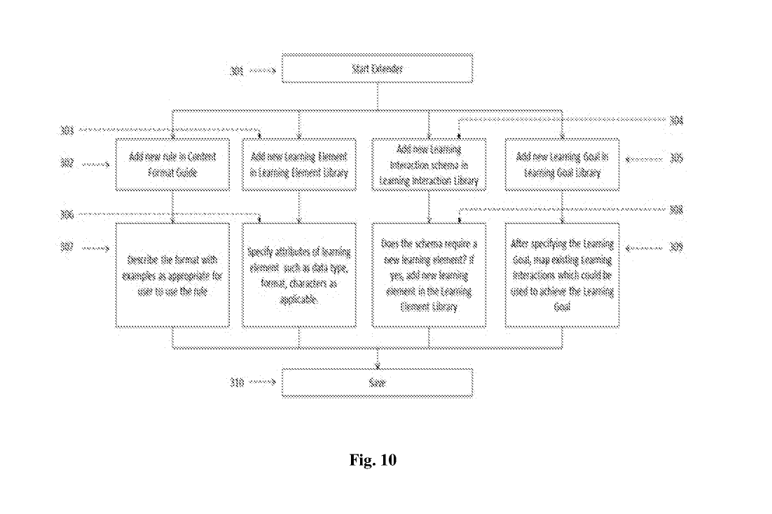

FIG. 10 presents a flow chart illustrating the process of extending the Learning Goal Library 111, Learning Element Library 109, and Learning Interaction Library 110 supported by Intelligent Learning Interaction Data Generator 101; and the rules described in Content Format Guide 104 that users need to follow while preparing input textual content. This method is used by the Admin User 118 to extend the libraries in their respective schema.

In step 301, Admin User 118 starts the Extender 117 and selects the Library or the format guide which needs to be extended.

If a new rule is to be added to the Content Format Guide 104, Admin User 118 selects step 302. In step 307, Admin User 118 describes the new rule with examples.

In order to add a new learning element to the Learning Element Library 109, Admin User 118 performs step 303. Learning Element Library has its own schema to for every learning element as presented in FIG. 4. In step 306, Admin User 118 specifies various attributes of the new learning element such as data type, format, number of characters needed to create that learning element.

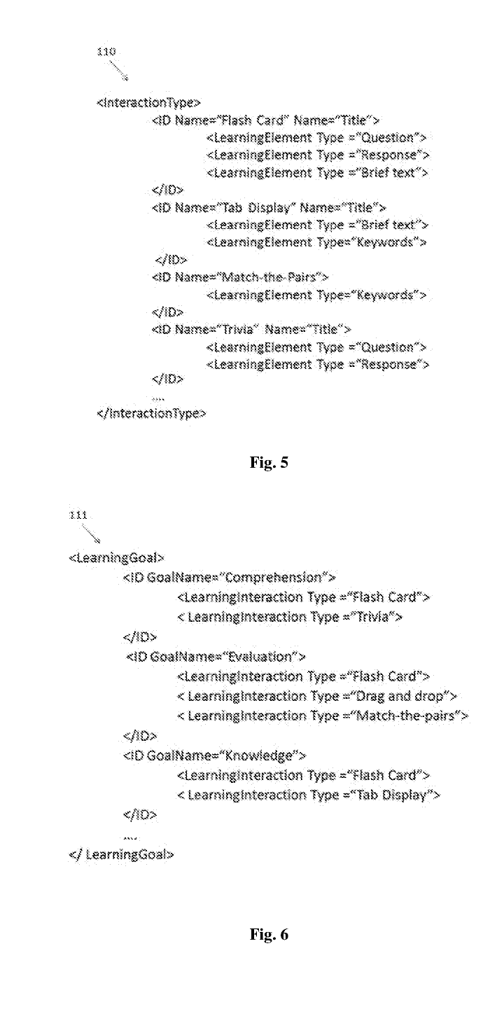

In order to add a new Learning Interaction to the Learning Interactions Library 110, Admin User 118 performs step 304. Learning Interaction Library 110 has its own schema to describe the Learning Interaction and various learning elements it supports as shown in FIG. 5. In step 308, Admin User 118 describes the new Learning Interaction. And while describing the same, if there are new learning elements supported by the interaction, it adds those learning elements as well to the Learning Element Library 109 using steps 303 and 306.

In order to add a new Learning Goal to the Learning Goal Library 111. Admin User 118 performs step 305. In step 309, after adding new learning goal, Admin User 118 also maps existing Learning Interactions to the newly added learning goal and updates the Learning Goal Library appropriately.

Once the action is performed Admin User 118 saves the information in step 310.

As understood by one of ordinary skill, programming is an art which allows many variations to achieve a single functionality. The given sequence of processing steps, or the broad organization thereof, or schemas presented using XML, are only exemplary, and there can be variations that result in the same functionality of the overall system without departing from the spirit and scope of the invention. Accordingly, it is intended that all matter contained in this disclosure is interpreted as illustrative and not in a limiting sense. It is considered that one of ordinary skill in the art, based on the disclosure herein, can implement the disclosed invention using techniques known to those of ordinary skill, and that those techniques vary without departing from the spirit and scope of the invention.

It is also understood that the claims in this disclosure are intended to cover generic and specific features of the invention described herein, and all statements of the scope of the invention which is a matter of language might be said to fall there between.

The terms and expressions which have been employed in this disclosure are used as the terms of description and not of limitations, and there is no intention in the use of such terms and expressions to exclude any equivalents of the features shown and described or portions thereof, but it is recognized that various modifications are possible within the scope of the claims.

What is claimed is:

1. A system for intelligently generating data for learning interactions from textual content based on learning goals, the system comprising:
i. a Theme Selector which identifies Themes based on Relationship Data provided by natural language processing libraries based on the content received from user;
ii. a Learning Element Generator that generates various learning elements based on format specified by Learning Element Library;
iii. a Learning Element Generator that lists learning interactions that can be created using these learning elements using Learning Interaction Library;
iv. a Learning Goal Mapper that shortlists Learning Interactions as per the learning goals specified by the external eLearning Application;
v. a Learning Interaction Selector that further selects learning interactions out of the interactions generated by the Learning Element Generator based on the interactions shortlisted by the Learning Goal Mapper; and
vi. an Extender that allows an administrative user to extend the Learning Element Library, Learning Interaction Library, and Learning Goal Library.

2. The system as in claim 1, wherein Learning Element Generator can generate various Learning Elements in the schema specified by the Learning Element Library and the Themes as specified by the Theme Selector.

3. The system as in claim 1, wherein Learning Element Generator lists all the interactions that can be created using these learning elements.

4. The system as in claim 1, wherein Learning Goal Mapper maps and shortlists Learning Interactions to the Learning Goals as specified by the Learning Goal Library.

5. The system as in claim 1, wherein, Learning Interaction Selector selects learning data for each theme, and further selects the final learning interactions that map to various Learning Goals, to be forwarded to external eLearning Application.

6. The system as in claim 1, wherein the Extender allows an administrative user the ability to extend the Learning Element Library, Learning Interactions Library, and Library Goal Library schemas.

7. A method for intelligently generating data for learning interactions from textual content based on learning goals, comprising the following steps:
i. identifying Themes in the content received from user based on Relationship Data provided by natural language processing libraries using a Theme Selector;
ii. generating various learning elements based on the format specified by Learning Element Library using a Learning Element Generator;
iii. identifying all possible Learning Interactions that can be formed using these learning elements by referring to Learning Interaction Library and creating such interactions using the Learning Element Generator,
iv. shortlisting, using a Learning Goal Mapper, those Learning Interactions that meet the learning goals specified by the external eLearning Application;
v. performing a final selection of learning interactions using a Learning Interaction Selector; and
vi. extending the Learning Element Library, the Learning Interaction Library and the Learning Goal Library using an Extender provided to an administrative user.

8. The method as in claim 7, wherein the Learning Element Generator generates various learning elements using the Themes as specified by the Theme Selector, and in the schema specified by the Learning Element Library.

9. The method as in claim 7, wherein Learning Element Generator lists all the interactions that can be created using these learning elements.

10. The method as in claim 7, wherein Learning Goal Mapper receives a Learning Goal XML from external application, maps Learning Interactions with the Learning Goals by referencing the Learning Goal Library and produces a shortlist of interactions.

11. The method as in claim 7, wherein Learning Interaction Selector shortlists learning interactions to be forwarded to external eLearning Application, with learning elements available for those Learning Interactions, for each Theme, mapping to various learning goals as specified in Learning Goal XML.
